(19) United States
(12) Patent Application Publication
(10) Pub. No.: US 2004/0029618 A1
(43) Pub. Date: Feb. 12, 2004

(54) Portable radio apparatus antenna

(76) Inventors: Kiyoshi Egawa, Yokosuka-shi (JP); Hideo Ito, Machida-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/381,316

(22) PCT Filed: Sep. 26, 2001
(86) PCT No.: PCT/JP01/08351

(30) Foreign Application Priority Data
Sep. 26, 2000 (JP) 2000-291446

(51) Int. Cl. H04B 1/034

(52) U.S. Cl. 455/562.1; 455/575.7; 455/95

(57) ABSTRACT

Mobile wireless device antenna configured such that a built-in supplementary antenna compensates for sensitivity deterioration that occurs in a main antenna due to mismatching polarized waves and directivity performance. Built-in antenna 60 is in a reverse L shape, and configured with a linear antenna element perpendicular to a base plane is bent in the middle parallel to the length direction of radio base 30. That is, built-in antenna 60 comprises linear antenna element-vertical part 62 that is perpendicular to the base plane and liner antenna element-horizontal part 64 that extends in the length direction of radio base 30. Of these, linear antenna element-vertical part 62 is connected contact 40b of switch 40 as a power supply element.

### TECHNICAL FIELD

The present invention relates to antennas of mobile wireless devices. More particularly, the present invention relates to antennas for use in mobile wireless devices that perform diversity reception.

### BACKGROUND ART

Mobile wireless devices typically employ diversity reception schemes such as shown in FIG. 1 to improve sensitivity deterioration that occurs upon reception due to fading. In FIG. 1, main antenna 12 that performs transmission and reception and built-in antenna 14 for reception alone are provided in an upper portion on radio base 10 in a case, below which radio circuit 16is installed. In the illustrated example, main antenna 12 and built-in antenna 14 are connected to radio circuit 16 by means of switch 18.

Main antenna 12 is provided such that it can be drawn out from the upper end of radio base 10 along the length direction (vertical direction Z) of the case.

Built-in antenna 14 is provided in an upper portion of radio base 10 so as to receive minimum influence from the user's hand that holds the case.

Given the above configuration, main antenna 12 and built-in antenna 14 configure the diversity antenna for reception. That is, the electric fields of main antenna 12 and built-in antenna 14 are compared upon reception, and the antenna of higher electric field is selected by means of switch 18.

As shown in FIG. 2, the directivity performance of main antenna 12 on the x-y plane is that it receives vertical polarized wave component V of high gain in the 90° and 270° directions, and horizontal polarized wave component H of low gain is in the 0° and 180° directions. Built-in antenna 14's directivity performance is virtually the same.

A base station transmits signals using vertical polarized waves. Provided that a user usually holds a mobile wireless device upright in the vertical direction while talking, signals transmitted from the base station and arriving from the 90° and 270° directions are received at high sensitivity.

However, a mobile wireless device is not always held upright in the vertical direction but held at various angles and in various directions during waiting and talk periods. For instance, such posture is possible where signals, in which the polarized waves are chiefly vertical polarized waves, arrive from the 0° and 180° directions. Then, gain in the 0° and 180° directions is low in both the main antenna and the built-in antenna, and furthermore, arriving signals and polarized waves from a base station do not match in their orientation, and thus there is severe sensitivity deterioration.

### DISCLOSURE OF INVENTION

The present invention therefore aims to provide a mobile wireless device antenna that enables a built-in supplementary antenna to compensate for a main antenna's sensitivity deterioration that occurs due to mismatching polarized waves and directivity performance.

The essence of the present invention lies in configuring a mobile wireless device antenna with a main antenna that performs transmission and reception and a built-in antenna that performs reception alone, whereby, when diversity reception is being performed by switching the two antennas or by using the both antennas without switching between them, the built-in antenna compensates for sensitivity deterioration that occurs in the main antenna when the mobile wireless device is in use at angles slanted from the vertical direction due to mismatching polarized waves and directivity performance.

One aspect of the present inventions shows an antenna for use in a mobile wireless device, comprising: a radio base; a main antenna that performs transmission and reception; a built-in supplementary antenna that has a directivity different than the main antenna, and performs reception alone, wherein the supplementary antenna has a vertical part that is perpendicular to a surface of the radio base, and a horizontal part that extends from an end of the vertical part parallel to the surface of the radio base in a length direction of the radio base.

### BRIEF DESCRIPTION OF DRAWINGS

FIG. 1 shows a configuration of a conventional mobile wireless device antenna;

FIG. 2 shows directivity performance in free space of the main antenna in FIG. 1;

FIG. 3 shows a configuration of a mobile wireless device antenna according to the first embodiment of the invention;

FIG. 4A shows directivity performance in free space of the main antenna in FIG. 3;

FIG. 4B shows directivity performance in free space of the built-in antenna in FIG. 3;

FIG. 5 shows a configuration of a mobile wireless device antenna according to the second embodiment of the invention;

FIG. 6 shows a configuration of a mobile wireless device antenna according to the third embodiment of the invention;

FIG. 7 shows a configuration of a mobile wireless device antenna according to the fourth embodiment of the invention;

FIG. 8 shows a configuration of a mobile wireless device antenna according to the fifth embodiment of the invention;

FIG. 9 shows a configuration of a mobile wireless device antenna according to the sixth embodiment of the invention;

FIG. 10 shows a configuration of a mobile wireless device antenna according to the seventh embodiment of the invention;

FIG. 11 shows a configuration of a mobile wireless device antenna according to the eighth embodiment of the invention;

FIG. 12 shows a configuration of a mobile wireless device antenna according to the ninth embodiment of the invention;

FIG. 13 shows a configuration of a mobile wireless device antenna according to the tenth embodiment of the invention;

FIG. 14 shows a configuration of a mobile wireless device antenna according to the eleventh embodiment of the invention;

FIG. 15 shows a configuration of a mobile wireless device antenna according to the twelfth embodiment of the invention;

FIG. 16 shows a configuration of a mobile wireless device antenna according to the thirteenth embodiment of the invention;

FIG. 17 shows a configuration of a mobile wireless device antenna according to the fourteenth embodiment of the invention; and

FIG. 18 shows a configuration of a mobile wireless device antenna according to the fifteenth embodiment of the invention.

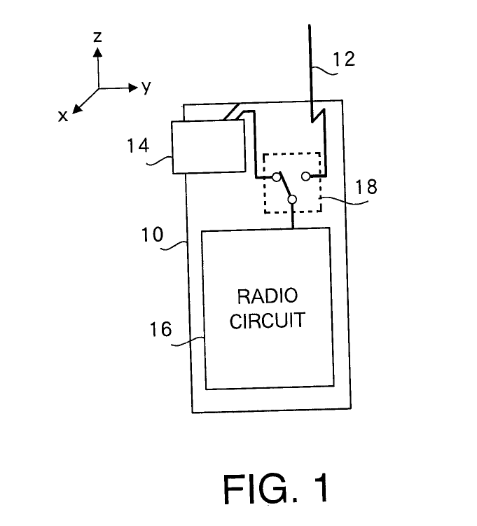

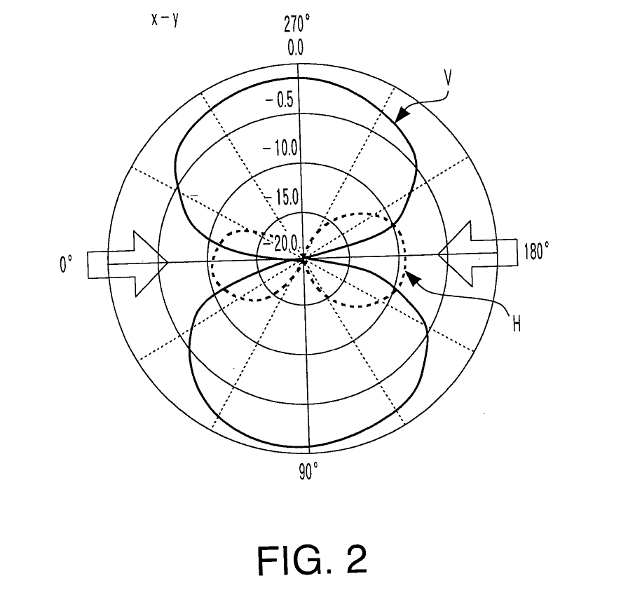

### BEST MODE FOR CARRYING OUT THE INVENTION

Preferred embodiments of the present embodiment will be described below with reference to the accompanying drawings.

(First Embodiment)

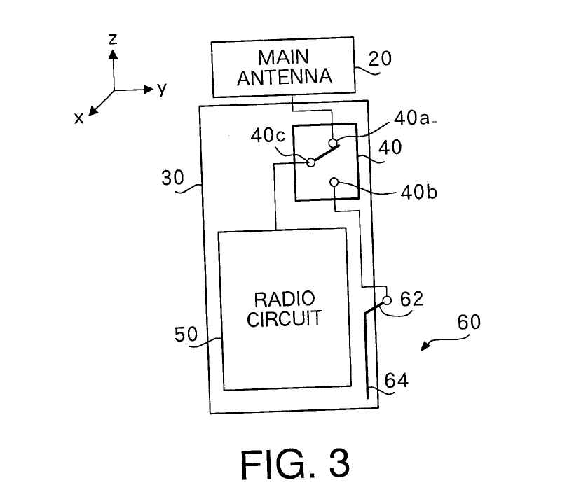

FIG. 3 is a configuration diagram showing a mobile wireless device antenna according to the first embodiment of the invention. In the case shown in FIG. 3, main antenna 20 is positioned in an upper portion in the vertical (Z) direction, below which radio base 30 is positioned.

Radio base 30 is a base plate of a rectangular shape, the vertical (Z) direction of which is its length direction, with switch 40 positioned in an upper portion thereof, below which radio circuit 50 is installed. In addition, on the front surface or on the back surface of radio base 30, built-in antenna 60 (supplementary antenna) of a reverse L shape is positioned on one side in the short direction of the portion where radio circuit 50 is installed.

One contact 40a of switch 40 is connected to main antenna 20, while the other contact 40b is connected to built-in antenna 60. In addition, shared contact 40c is connected to radio base 30.

Built-in antenna 60 has a reverse L shape as described above, and configured such that a linear antenna element that is perpendicular to the base plane is bent in the middle to be parallel to the length direction of radio base 30. Built-in antenna 60 thus comprises linear antenna element-vertical part 62 that is perpendicular to the base plane, and linear antenna element-horizontal part 64 that is parallel to the base plane and that runs along the length direction of radio base 30. Of these, linear antenna element-vertical part 62 is connected to contact 40b of switch 40 as a power supply element.

Next, the directivity performance of the above-configured mobile wireless device antenna will be explained.

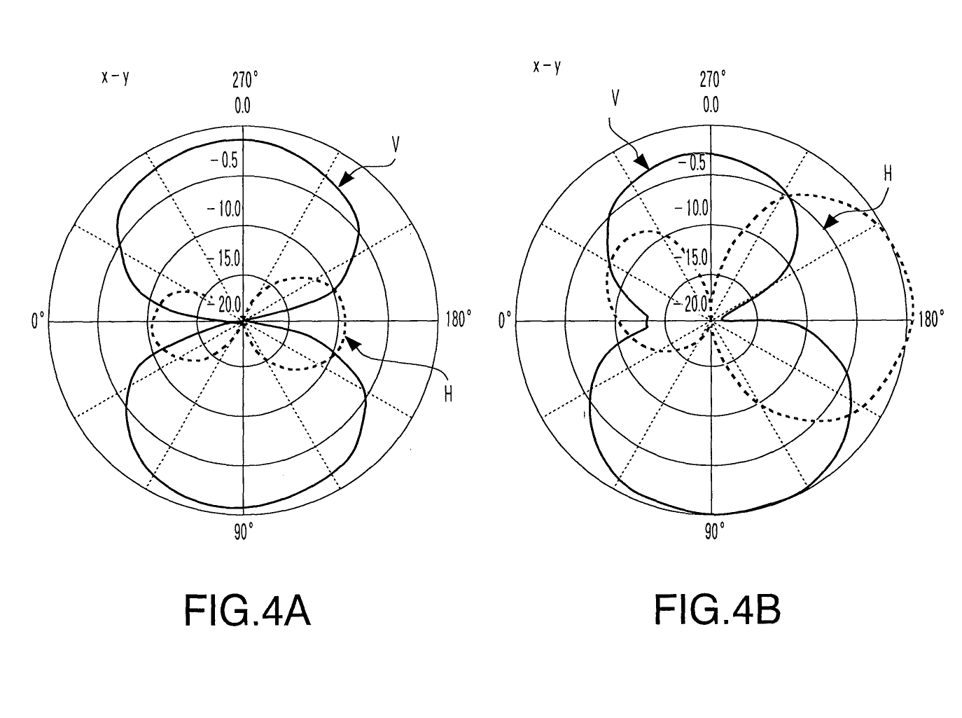

FIG. 4A shows main antenna 20's directivity performance in free space. As shown in FIG. 4A, the directivity performance of main antenna 20 on the x-y plane is that it receives vertical polarized wave component V of high gain in the 90° and 270° directions, and horizontal polarized wave component H of low gain in the 0° and 180° directions.

Moreover, FIG. 4B shows built-in antenna 60's directivity performance in free space. As shown in FIG. 4B, the directivity performance of built-in antenna 60 on the x-y plane is that it receives vertical polarized wave component V of high gain in the 90° and 270° directions, and horizontal polarized wave component H of high gain in the 0° and 180° directions.

Therefore, when a mobile wireless device in use is inclined from vertical to horizontal, built-in antenna 60 receives the waves at high sensitivity, where these waves are transmitted from a base station, are primarily vertical polarized waves, and arrive from the 180° direction. In order to perform diversity reception, the mobile wireless device compares the electric fields of main antenna 20 and built-in antenna 60, and selects the antenna of higher electrical field by means of switch 40, so that the built-in antenna compensates for the main antenna's sensitivity deterioration due to change in the angle of the mobile wireless device or posture change.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance.

Incidentally, although the figure shows that main antenna 20 and built-in antenna 60 are switched by means of switch 40, using the both antennas without switching between them still achieves the same effect.

(Second Embodiment)

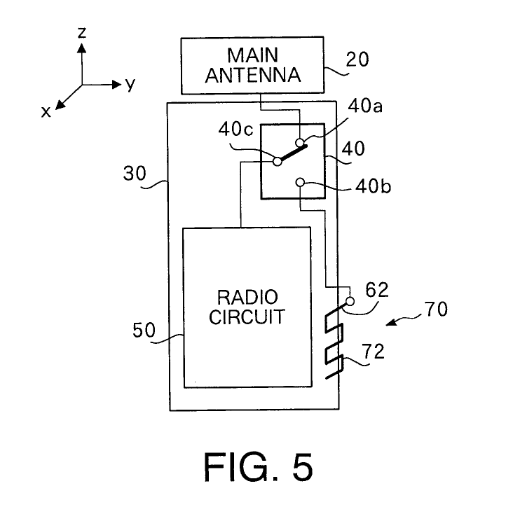

FIG. 5 is a configuration diagram showing mobile wireless device antenna according to the second embodiment of the invention. Parts in FIG. 5 identical to those of FIG. 3 are assigned the same numerals as in FIG. 3 without further explanations.

As shown in FIG. 5, built-in antenna 70 of the present embodiment replaces linear antenna element-horizontal part 64 of built-in antenna 60 of the first embodiment with zigzag antenna element-horizontal part 72. The zigzag plane is perpendicular to the base plane.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance. In addition, zigzag antenna element-horizontal part 72 enables further miniaturization of built-in antenna 70.

(Third Embodiment)

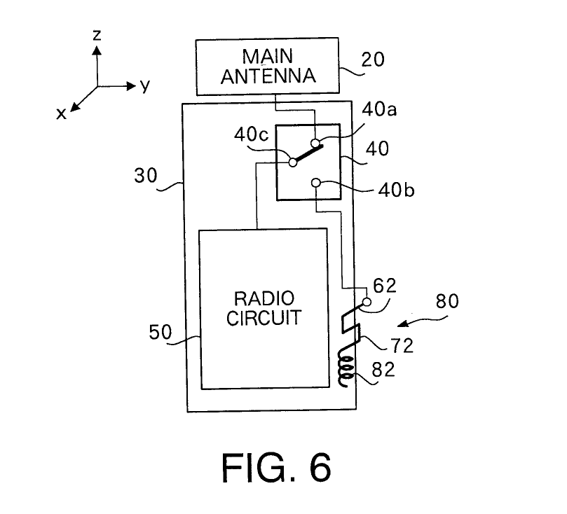

FIG. 6 is a configuration diagram showing mobile wireless device antenna according to the third embodiment of the invention. Parts in FIG. 6 identical to those of FIG. 5 are assigned the same numerals as in FIG. 5 without further explanations.

As shown in FIG. 6, built-in antenna 80 of the present embodiment is configured such that reactance 82 is installed at an end of zigzag antenna element-horizontal part 72 of built-in antenna 70 of the second embodiment. By providing this reactance 82, the electrical length of an antenna element becomes longer than the actual element length, so that the element length can be shortened.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance. In addition, reactance 82 enables further miniaturization of built-in antenna 80.

(Fourth Embodiment)

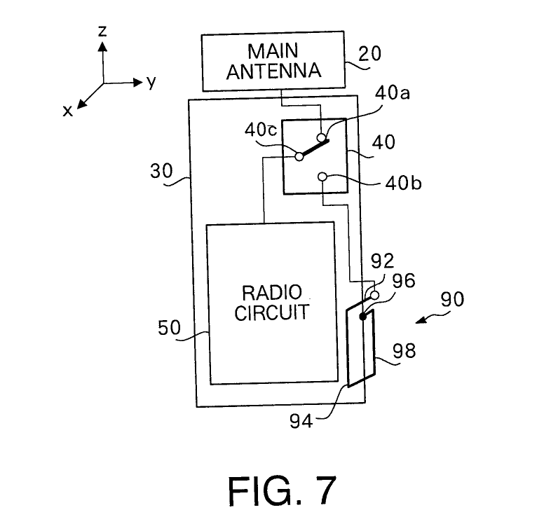

FIG. 7 is a configuration diagram showing mobile wireless device antenna according to the fourth embodiment of the invention. Parts in FIG. 7 identical to those of FIG. 3 are assigned the same numerals as in FIG. 3 without further explanations.

As shown in FIG. 7, built-in antenna 90 of the present embodiment is configured such that one linear antenna is bent into a rectangular shape in the plane that runs parallel to a side in the length direction of the base plane and that is perpendicular to the base plane. Vertical end portion 92 formed at one end is connected to contact 40b of switch 40 as a power supply end, and vertical end portion 96 formed at the other end is short-circuited to radio base 30.

That is, built-in antenna 90 comprises two linear antenna elements 94 and 98 positioned in parallel with appropriate distance in the X direction on a plane that is parallel to the length direction of the base plane and that is perpendicular to the base plane. Two parallel linear antenna elements 94 and 98 are short-circuited at one end thereof. The other end of linear antenna element 94 is bent perpendicularly and connected to contact 40b of switch 40, and likewise the other end of linear antenna element 98 is bent perpendicularly and short-circuited to radio base 30.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance. Moreover, the configuration of built-in antenna 90 comprising two parallel linear antenna elements increases impedance, so that matching can be performed at more ease and the broadening of bandwidth can be realized.

(Fifth Embodiment)

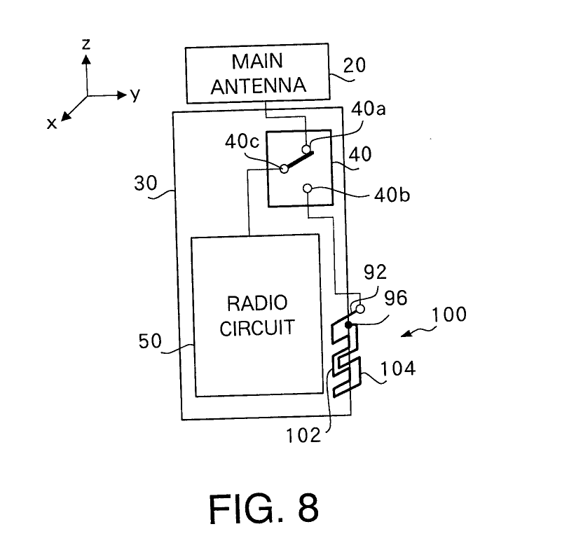

FIG. 8 is a configuration diagram showing mobile wireless device antenna according to the fifth embodiment of the invention. Parts in FIG. 8 identical to those of FIG. 7 are assigned the same numerals as in FIG. 7 without further explanations.

As shown in FIG. 8, built-in antenna 100 of the present embodiment is configured such that two parallel linear antenna elements 94 and 98 of built-in antenna 90 of the fourth embodiment are bent in a zigzag shape to make two parallel zigzag antenna elements 102 and 104.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance. Moreover, the two parallel antenna elements in a zigzag shape enables a further miniaturized built-in antenna to increases impedance, so that matching can be performed at more ease and the broadening of bandwidth can be realized.

(Sixth Embodiment)

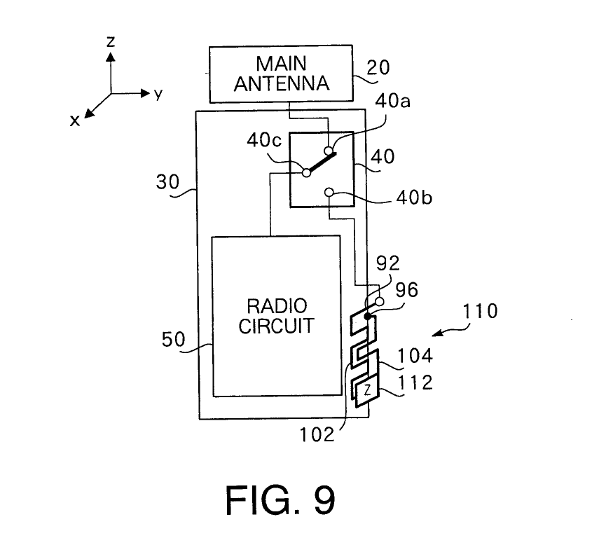

FIG. 9 is a configuration diagram showing mobile wireless device antenna according to the sixth embodiment of the invention. Parts in FIG. 9 identical to those of FIG. 8 are assigned the same numerals as in FIG. 8 without further explanations.

As show in FIG. 9, built-in antenna 110 of the present embodiment is configured such that the ends of two parallel zigzag antenna elements 102 and 104 that constitute built-in antenna 100 of the fifth embodiment are not short-circuited but are open, and impedance 112 is disposed at these open ends.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance. Moreover, impedance 112 enables further broadening of bandwidth and miniaturization.

(Seventh Embodiment)

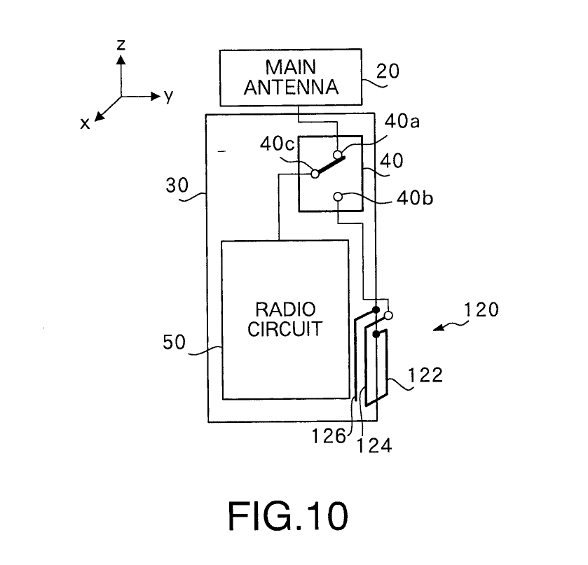

FIG. 10 is a configuration diagram showing mobile wireless device antenna according to the seventh embodiment of the invention. Parts in FIG. 10 identical to those of FIG. 3 are assigned the same numerals as in FIG. 10 without further explanations.

As shown in FIG. 10, built-in antenna 120 of the present embodiment comprises three liner antenna elements 122, 124, and 126 positioned in parallel with appropriate distance in the X direction on a plane that is parallel to the length direction of the base plane and that is perpendicular to the base plane. Similar to built-in antenna 90 of the fourth embodiment, two parallel linear antenna elements 122 and 124 are short-circuited at one end thereof. The other end of linear antenna element 122 is bent perpendicularly and connected to contact 40b of switch 40 as a power supply element. Likewise, the other end of linear antenna element 124 is bent perpendicularly and short-circuited to radio base 30.

Now, the remaining linear antenna element 126 is a parasitic element, with one end thereof open and the other end bent perpendicularly and short-circuited to radio base 30. Proving built-in antenna 120 with liner antenna element 126 as a parasitic element is equivalent to providing built-in antenna 90 of the fourth embodiment with a reactance.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance. Moreover, the reactance enables further broadening of bandwidth.

(Eighth Embodiment)

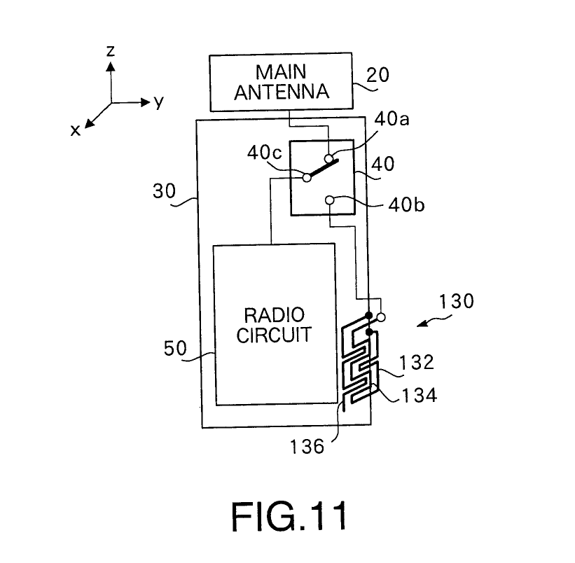

FIG. 11 is a configuration diagram showing a mobile wireless device antenna according to the eighth embodiment of the invention. Parts in FIG. 11 identical to those of FIG. 10 are assigned the same numerals as in FIG. 10 without further explanations.

As shown in FIG. 11, built-in antenna 130 of the present embodiment comprises three parallel zigzag antenna elements 132, 134, and 136, which are equivalent of three parallel linear antenna elements 122, 124, and 126 of built-in antenna 120 of the seventh embodiment, that are bent in a zigzag shape.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance. Moreover, the three parallel linear antenna elements in a zigzag shape makes possible further miniaturization of a built-in antenna and further broadening of bandwidth.

(Ninth Embodiment)

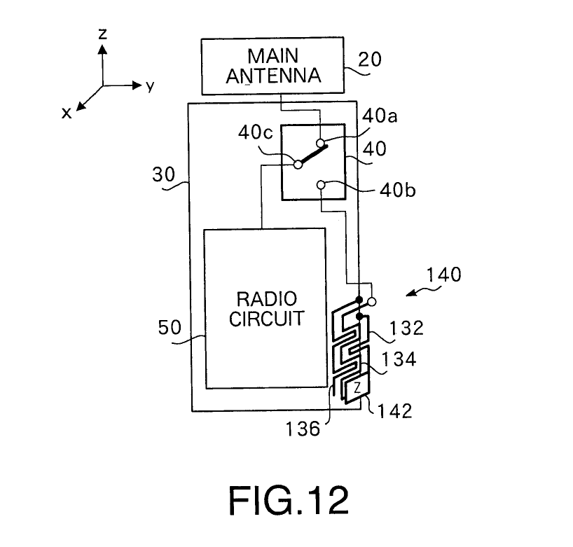

FIG. 12 is a configuration diagram showing a mobile wireless device antenna according to the ninth embodiment of the invention. Parts in FIG. 12 identical to those of FIG. 11 are assigned the same numerals as in FIG. 11 without further explanations.

As shown in FIG. 12, built-in antenna 140 of the present embodiment is configured such that the ends of two parallel zigzag antenna elements 132 and 134 of built-in antenna 130 of the eighth embodiment are not short-circuited but are open, and impedance 142 is disposed at these open ends.

According to the mobile wireless device antenna of the present embodiment, a built-in antenna can receive, at high gain, the waves that arrive in the directions where the main antenna is at low gain, so that the mobile wireless device can be used at various angles, and still the built-in antenna compensates for sensitivity deterioration that occurs in the main antenna due to mismatching polarized waves and directivity performance. Moreover, impedance 142 enables further miniaturization and boarding of bandwidth.

(Tenth Embodiment)

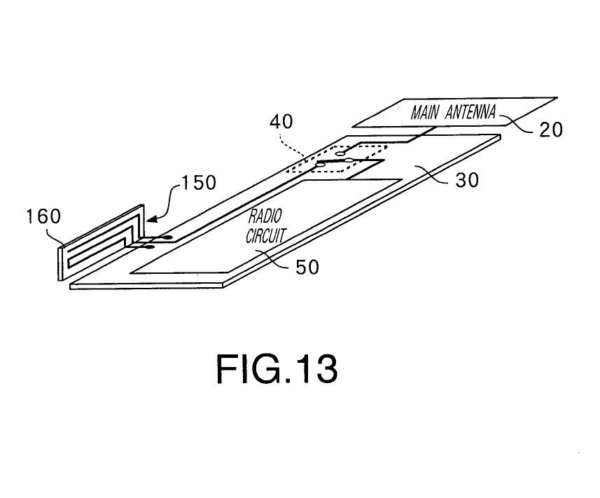

FIG. 13 is a configuration diagram showing a mobile wireless device antenna according to the tenth embodiment of the invention. Parts in FIG. 13 identical to those of FIG. 3 are assigned the same numerals as in FIG. 3 without further explanations.

As shown in FIG. 13, built-in antenna 150 of the present embodiment is positioned on board member 160 provided at one side of radio base 30 and connected directly to radio base 30.

The built-in antenna provided on board member 160 in the illustrated example has the same shape as built-in antenna 120 of the seventh embodiment and is made of three parallel-placed linear antenna elements. However, this should not be construed as limiting, and any antenna from the above first through ninth embodiments can replace built-in antenna 150. Moreover, although board member 160 is provided on the front surface of radio base 30 in the above configuration, it can be on the back surface as well.

Incidentally, as to how to configure built-in antenna 150 on the surface of board member 160, for instance, a sheet on which built-in antenna 150 is printed can be affixed on board member 160, or, built-in antenna 150 can be directly printed on the surface of board member 160.

The mobile wireless device antenna of the present embodiment thus achieves the same effect as the above first through ninth embodiments, and enables further thin-modeling of built-in antenna.

(Eleventh Embodiment)

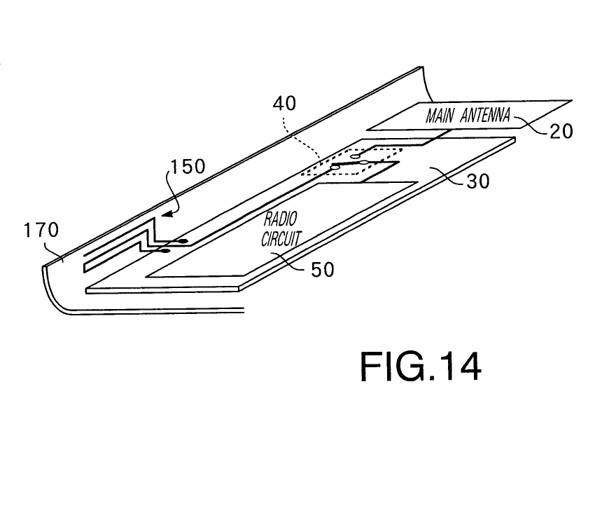

FIG. 14 is a configuration diagram showing a mobile wireless device antenna according to the eleventh embodiment of the invention. Parts in FIG. 14 identical to those of FIG. 13 are assigned the same numerals as in FIG. 13 without further explanations.

As shown in FIG. 14, built-in antenna 150 of the present embodiment is positioned on the surface of case 170 provided on one side of radio base 30, and is directly connected to radio base 30.

The built-in antenna provided on case 170 in the illustrated example has the same shape as built-in antenna 120 of the seventh embodiment and is made of three parallel-placed linear antenna elements. However, this should not be construed as limiting, and any antenna from the above first through ninth embodiments can replace built-in antenna 150. Moreover, although built-in antenna 150 is disposed on case 170 in such a way that it is equivalent to the front surface of radio base 30, it is also possible to use case 170 in a way that makes it equivalent to the back surface of case 170.

Incidentally, as to how to configure built-in antenna 150 on the surface of case 170, for instance, a sheet on which built-in antenna 150 is printed can be affixed on case 170, or, built-in antenna 150 can be directly printed on the surface of case 170.

The mobile wireless device antenna of the present embodiment thus achieves the same effect as the above first through ninth embodiments, and enables further miniaturization and thin-modeling of a built-in antenna.

(Twelfth Embodiment)

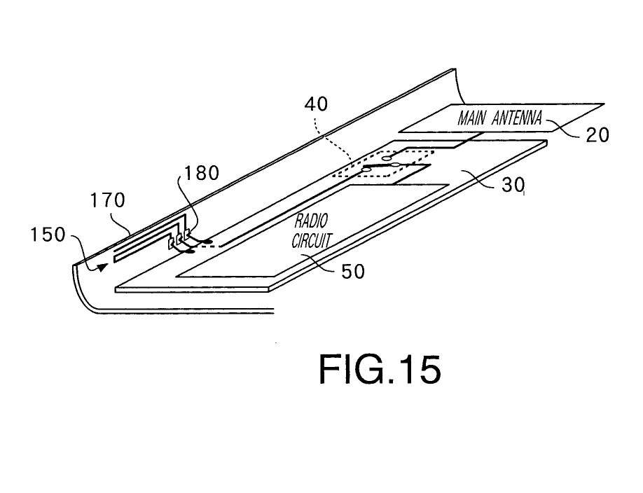

FIG. 15 is a configuration diagram showing a mobile wireless device antenna according to the twelfth embodiment of the invention. Parts in FIG. 15 identical to those of FIG. 14 are assigned the same numerals as in FIG. 14 without further explanations.

As shown in FIG. 15, built-in antenna 150 of the present embodiment is positioned for instance on case 170 provided on one side of radio base 30, and is connected to radio base 30 through power-supply spring 180 provided on one side of radio base 30. Power-supply spring 180 is a spring of a board shape or a coiled spring.

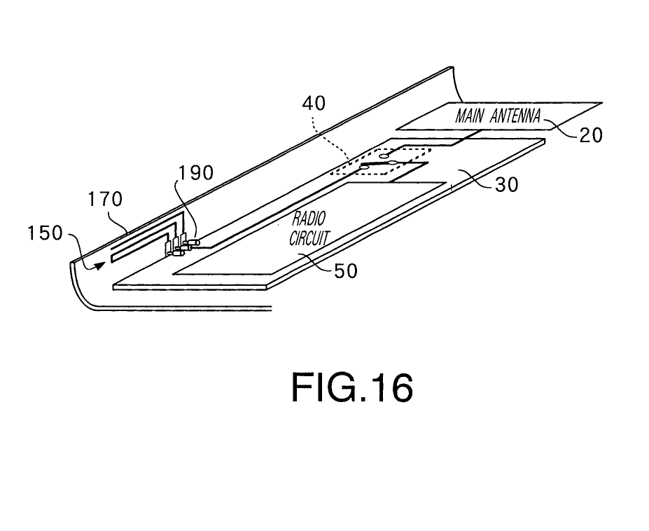

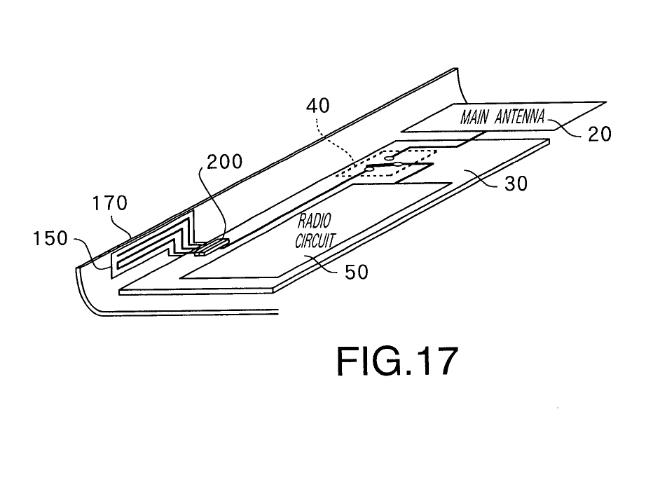

The built-in antenna provided on case 170 in the illustrated example has the same shape as built-in antenna 120 of the seventh embodiment and is made of three parallel-placed linear antenna elements. However, this should not be construed as limiting, and any antenna from the above first through ninth embodiments can replace built-in antenna 150. Furthermore, although the present embodiment is configured such that built-in antenna 150 and radio base 30 are connected by means of power-supply spring 180, it is also possible to use spring pin 190 as shown in FIG. 16 or use connector 200 as shown in FIG. 17.

The mobile wireless device antenna of the present embodiment thus achieves the same effect as the above first through ninth embodiments, enables further miniaturization and thin-modeling of a built-in antenna, and furthermore reinforces the structure of the connection point between a built-in antenna and a radio base.

(Thirteenth Embodiment)

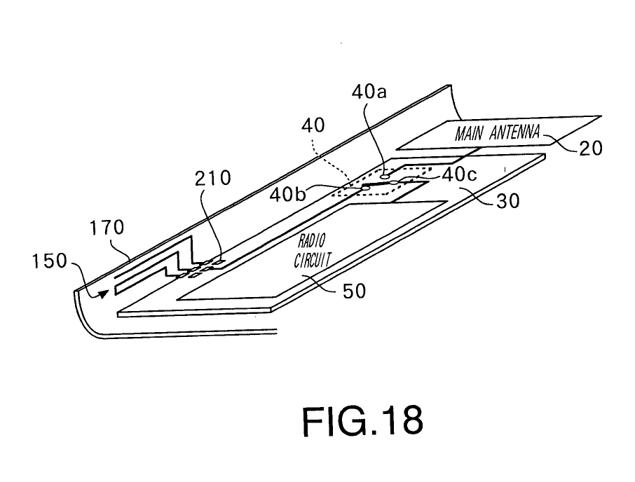

FIG. 18 is a configuration diagram showing a mobile wireless device antenna according to the thirteenth embodiment of the invention. Parts in FIG. 18 identical to those of FIG. 14 are assigned the same numerals as in FIG. 14 without further explanations.

As shown in FIG. 18, built-in antenna 150 of the present embodiment is positioned for instance on case 170 provided at one side of radio base 30 and is connected to radio base 30 by way of electrostatic connection with interstice 210 in between. Interstice 210 comprises a pair of electrode parts. Built-in antenna 150 is connected to one electrode part, and contact 40b of switch 40 is connected to the other electrode part.

The built-in antenna provided on case 170 in the illustrated example has the same shape as built-in antenna 120 of the seventh embodiment and is made of three parallel-placed linear antenna elements. However, this should not be construed as limiting, and any antenna from the above first through ninth embodiments can replace built-in antenna 150.

The mobile wireless device antenna of the present embodiment thus achieves the same effect as the above first through ninth embodiments, enables further miniaturization and thin modeling of a built-in antenna, and furthermore simplifies the structure of the connection point between a built-in antenna and a radio base.

Although the above twelfth and thirteenth embodiments show configurations in which built-in antenna 150 is disposed on case 170, it can be disposed on board member 160, and still achieves the same effect.

As described above, the present invention enables a built-in antenna to compensate for the main antenna's sensitivity deterioration due to mismatching polarized waves and directivity performance.

The present application is based on Japanese patent application No. 2000-291446, filed on Sep. 26, 2000, entire content of which is expressly incorporated herein for reference.

### INDUSTRIAL APPLICABILITY

The present invention relates to antennas for use in mobile wireless devices, and particularly suitable for use in mobile wireless devices that perform diversity reception.

1. A mobile wireless device antenna, comprising:
a radio base;
a main antenna that performs transmission and reception;
a built-in supplementary antenna that has a directivity different than said main antenna, and performs reception alone,
wherein said supplementary antenna has:
a vertical part that is perpendicular to a surface of said radio base; and
a horizontal part that extends from an end of said vertical part parallel to the surface of said radio base in a length direction of said radio base.

2. The mobile wireless device antenna according to claim 1, wherein said horizontal part is configured in a zigzag shape on a plane that is perpendicular to the surface of said radio base.

3. The mobile wireless device antenna according to claim 1, wherein said horizontal part is equipped with a reactance.

4. A mobile wireless device antenna comprising:
a radio base;
a main antenna that performs transmission and reception;
a built-in supplementary antenna that has a directivity different than said main antenna, and performs reception alone,
wherein said supplementary antenna has:
a vertical part that is perpendicular to a surface of said radio base; and
a first horizontal part that extends from an end of said vertical part parallel to the surface of said radio base in a length direction of said radio base; and
a second horizontal part that is parallel to said first horizontal part, one end thereof short circuited to said first horizontal part, and the other end thereof short circuited to said radio base.

5. The mobile wireless device antenna according to claim 4, wherein the first and second horizontal parts are configured in a zigzag shape on a plane that is perpendicular to the surface of said radio base.

6. The mobile wireless device antenna according to claim 4, wherein an impedance is provided in a middle between the first and second horizontal parts.

7. A mobile wireless device antenna comprising:
a radio base;
a main antenna that performs transmission and reception; and
a built-in supplementary antenna that comprises a first antenna element and a second antenna element, has a directivity different than said main antenna, and performs reception alone,
wherein said first antenna element comprises:
a vertical part that is perpendicular to a surface of said radio base; and
a first horizontal part that extends from an end of said vertical part parallel to the surface of said radio base in a length direction of said radio base,
a second horizontal part that is parallel to said first horizontal part, one end thereof short circuited to said first horizontal part, and the other end thereof short circuited to said radio base, and,
wherein said second antenna element comprises a third horizontal part that is parallel to the first and second horizontal parts, one end thereof being short-circuited to the surface of said radio base, and the other end thereof being open.

8. The mobile wireless device antenna according to claim 7, wherein the first, second, and third horizontal parts are configured in a zigzag shape on a plane that is perpendicular to the surface of sad radio base.

9. The mobile wireless device antenna according to claim 7, wherein an impedance is provided in a middle between the first and second horizontal parts.

10. The mobile wireless device antenna according to one of claims 1, 4, and 7, wherein said built-in antenna is provided on one of, a surface of a flat member, and the surface of a case; and, wherein said vertical part is directly connected to said radio base.

11. The mobile wireless device antenna according to one of claims 1, 4, and 7, wherein said supplementary antenna is provided on one of, a surface of a flat member, and a surface of a case, and connected to said radio base by connecting means.

12. The mobile wireless device antenna according to one of claims 1, 4, and 7, wherein said supplementary antenna is provided on one of, a surface of a flat member, and a surface of a case, and connected to said radio base by way of electrostatic connection with an intervening interstice.
